(19) United States
(12) Patent Application Publication
(10) Pub. No.: US 2026/0295934 A1
(43) Pub. Date: Oct. 1, 2026

(54) CONSTRUCTION MATERIAL FOR ADDITIVE MANUFACTURING, COMPOSITION, PROCESS AND METHOD THEREOF

(71) Applicant: 9418-4256 QUEBEC INC., Quebec (CA)

(72) Inventors: Véronique COTE, Quebec (CA); Hugo THIBAUDEAU, Quebec (CA); Gabrielle NADEAU, Terrebonne (CA); Cédric HARVEY, Trois-Riviéres (CA)

(21) Appl. No.: 19/629,923

(22) Filed: Mar. 26, 2026

Related U.S. Application Data
(60) Provisional application No. 63/778,066, filed on Mar. 26, 2025.

(51) Int. Cl. B29C 64/141; B29C 64/194; B29C 64/209; B29C 64/227; B29C 64/295; B29K 1/00; B29K 509/00; B33Y 10/00; B33Y 40/20; B33Y 70/10; C08K 3/22; C08K 3/34

(52) U.S. Cl. CPC B29C 64/141; B29C 64/194; B29C 64/209; B29C 64/227; B29C 64/295; B33Y 10/00; B33Y 40/20; B33Y 70/10; C08K 3/22; C08K 3/34; B29K 2001/08; B29K 2509/00; B29K 2995/0063; B29K 2995/0094; C08K 2003/2206

(57) ABSTRACT

The present disclosure pertains to cellulosic fiber-based compositions comprising water, at least one hydraulic binder, and cellulosic fibers. The compositions comprise between about 10 vol % and about 45 vol % of cellulosic fibers and wherein the compositions are construction material compositions for additive manufacturing. The present disclosure also pertains to processes to obtain the compositions and to methods of producing a construction article by additive manufacturing using the compositions.

### CROSS REFERENCE TO RELATED APPLICATION

The present application claims priority to and the benefit of U.S. Provisional Patent Application No. 63/778,066, filed on Mar. 26, 2025, titled “CONSTRUCTION MATERIAL FOR ADDITIVE MANUFACTURING, COMPOSITION, PROCESS AND METHOD THEREOF”.

### TECHNICAL FIELD

The technical field relates to compositions of construction materials. In particular, the technical field related to compositions of construction materials for additive manufacturing, processes of making the compositions and methods of producing construction articles.

### BACKGROUND

Additive manufacturing or 3D-printing of construction articles or architectural elements presents numerous advantages such as the precise material distribution according to structural and aesthetic needs.

A current limitation of additive manufacturing lies in the low tensile strength of architectural elements produced using this manufacturing method. The complex shapes that can be produced using additive manufacturing of construction materials (such as cementitious materials) complicate the integration of steel reinforcement, as is the case with conventional concrete.

The use of discontinuous fibers has attracted interest in additive manufacturing since the fibers can be incorporated as a component of printable material compositions and can be successfully extruded without clogging at limited fiber volume. The use of fibers can enhance the tensile strength and toughness of the architectural elements and reduce the risk of cracking and crack width due to shrinkage.

Natural fibers (i.e. cellulosic fibers) can reduce concrete cracking and increase tensile strength. Cellulosic fibers can enhance the internal stress distribution and improve the stability of concrete; however, compressive strength is reduced. Cellulosic fibers can also enhance the thermal insulation and noise reduction of concrete by reducing its density. Furthermore, adding natural fibers in construction material compositions is a more sustainable alternative to traditional materials known to contain a large amount of Portland cement which raises questions about the environmental sustainability of more traditional construction materials compositions.

Construction materials with lower energy and intrinsic carbon such as lime mortar offer an alternative to standard concrete, but their integration into additive manufacturing systems remains difficult. This is due to the high proportion of vegetal fibers that should be added in such a mixture in order to obtain adequate mechanical properties. For example, mixtures intended for the manufacture of hemp-based concrete are known to be unsuitable for use in additive manufacturing due to excessive proportion and size of hemp fibers. Rheological characteristics (fluidity, etc.) of such vegetal fibers-based concrete are not adapted for additive manufacturing and cause blockages or damage to conventional pumping systems used for this manufacturing method, in particular progressive cavity pumps.

Therefore, there is a need to develop construction material compositions comprising an increased amount of cellulosic fibers and having rheological characteristics compatible with additive manufacturing (i.e. can be extruded without causing blockages) while maintaining adequate mechanical and self-supporting properties, as defined by the construction standards.

### SUMMARY

According to a general aspect, there is provided a cellulosic fiber-based concrete composition comprising: water, at least one hydraulic binder, and cellulosic fibers. The composition comprises between about 10 vol % and about 45 vol % of cellulosic fibers and the composition is a construction material composition for additive manufacturing.

In an embodiment, the fibers have a length of between about 0.25 mm to about 20 mm. For instance, the fibers can have a length of less than 12 mm.

In an embodiment, the composition comprises: from about 20% to about 50% by volume of water, from about 15% to about 50% by volume of the at least one hydraulic binder. In an embodiment, the composition comprises: from about 35 vol % to about 45 vol % of the cellulosic fibers and, in a particular embodiment, the composition comprises: from about 37 vol % to about 41 vol % of the cellulosic fibers.

In an embodiment, the cellulosic fibers are selected from synthetic cellulosic fibers, semi-synthetic cellulosic fibers, natural cellulosic fibers and mixtures thereof.

In an embodiment, the at least one hydraulic binder is selected from lime, pozzolan and mixtures thereof.

For instance, the composition can comprise: from about 25% to about 35% by volume of water, from about 8% to about 35% by volume of lime, from about 2% to about 35% by volume of pozzolan, and from about 25% to about 45% by volume of natural cellulosic fibers.

For instance, the composition can comprise: from about 25% to about 35% by volume of water, from about 8% to about 25% by volume of lime, from about 15% to about 25% by volume of pozzolan, and from about 35% to about 45% by volume of natural cellulosic fibers.

The natural cellulosic fibers can be selected from the group consisting of plant-based fibers, agricultural residue fibers, wood-based fibers and any mixture thereof. The natural cellulosic fibers can be selected from the group consisting of hemp, bamboo, jute, papyrus, flax, sugarcane, bagasse, wood chip and any mixture thereof. The plant-based fibers can be hemp fibers.

In an embodiment, the composition further comprises cement. For instance, the composition can comprise from about 1% to about 25% by volume of cement.

According to another general aspect, there is provided a process for producing the composition as defined above. The process can comprise the following steps: mixing the water and the at least one hydraulic binder, optionally in a mixer, to obtain a first substantially homogeneous mixture (or an hydraulic binder mixture), adding the cellulosic fibers to the hydraulic binder mixture to obtain a second mixture (or a cellulosic fibers and hydraulic binder premix), and mixing the cellulosic fibers and hydraulic binder premix to obtain a third mixture (or the cellulosic fiber-based composition), which can be substantially homogeneous. Mixing can be performed using a mortar mixer and/or at between about 700 rpm and about 900 rpm.

In an embodiment, cement can be added as a further hydraulic binder during the step of obtaining the first substantially homogenous mixture.

In an embodiment, a viscosity of the construction material composition is adjusted by addition of water and/or a mixture of water and an additional amount of the at least one hydraulic binder to the substantially homogeneous mixture. The viscosity of the construction material composition can be between about 50,000 CPS and about 200,000 CPS and, in some embodiments, between about 70,000 CPS and about 150,000 CPS.

According to another general aspect, there is provided a method of producing a construction article by additive manufacturing. The method comprises: (a′) conveying the composition as defined above, from a mixing system to a 3D-printer using a pumping system; (b′) injecting the composition in the 3D-printer; (c′) extruding the composition through a printing head on a surface using a predetermined shape programmed using a computer within the 3D-printer, (d′) continuously extruding the composition horizontally layer-by-layer, following the predetermined shape to obtain the construction article in three dimensions, and (e′) curing of the construction article.

According to still another general aspect, there is provided a method of producing a construction article by additive manufacturing, the method comprising: conveying the cellulosic fiber-based composition as described above from a mixing unit to a 3D-printer using a pumping system; injecting the cellulosic fiber-based composition in the 3D-printer; extruding a layer of the cellulosic fiber-based composition through a printing head on a surface according to a predetermined shape programmed using a computer operatively connected to the 3D-printer; adding additional layers of the cellulosic fiber-based composition layer-by-layer according to the predetermined shape to produce an extruded construction article in 3 dimensions; and curing the extruded construction article to produce the construction article.

In an embodiment, the pumping system comprises a progressive cavity pump and/or the printing head comprises a cylindrical nozzle.

In an embodiment, a layer height is between about 4 mm to about 10 mm.

In an embodiment, in step (d′), a number of contours is between 1 and 3 and/or a number of buttresses is between 1 and 3. In a non-limitative embodiment, the extruded construction article comprises 3 contours and the layer height of the extruded construction article is about 7 mm. In still another non-limitative embodiment, the extruded construction article comprises 1 buttress and the layer height of the extruded construction article is about 5 mm.

In an embodiment, in step (e′), curing is performed at a temperature between 15° C. and 30° C. Curing can be performed at a humidity level comprised between 40% and 60%. Curing can be performed during 20 to 30 days.

In an embodiment, the additional layers of the cellulosic fiber-based composition are added horizontally layer-by layer to produce the extruded construction article.

### BRIEF DESCRIPTION OF THE FIGURES

FIG. 1 shows an axonometric view of a block.

FIG. 2 shows photographs of different views of concrete Blocks No 1, 2, 3, 4 and 5: a) Top view, b) Front view, c) Rear view, d) Lateral view and e) Axonometry.

FIG. 3 shows photographs of different views of concrete Blocks No 6 and 7 (Scan 1 and Scan 2): a) Top view, b) Front view, c) Rear view, d) Lateral view and e) Axonometry.

FIG. 4 shows photographs of different views of concrete Blocks No 8, 9 (Scan 1 and Scan 2), 10, and 11: a) Top view, b) Front view, c) Rear view, d) Lateral view and e) Axonometry.

FIG. 5 shows photographs of different views of concrete Blocks No 12, 13, and 14: a) Top view, b) Front view, c) Rear view, d) Lateral view and e) Axonometry.

FIG. 6 shows photographs of different views of concrete Blocks 15, 16, 17, 18, and 19: a) Top view, b) Front view, c) Rear view, d) Lateral view and e) Axonometry.

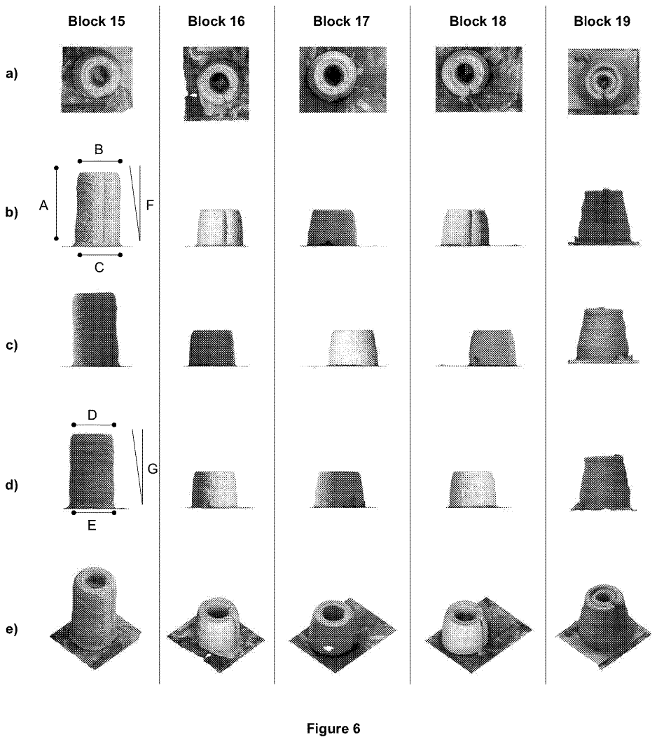

FIG. 7 shows photographs of an experimental setup for a compression test on a square specimen (left panel), an experimental setup for a flexural test (center panel), and an experimental setup for a compression test on a cylindrical specimen (right panel).

FIG. 8 shows photographs of wet bioconcrete pastes (left panel and right panel) for viscosity tests.

FIG. 9 shows a diagram of cone dimensions (left panel) and a photograph of filling the cone for bioconcrete sag tests (right panel).

FIG. 10 shows photographs of sag test results for samples M-A1 (left panel), M-A2 (center panel), and M-A3 (right panel).

### DETAILED DESCRIPTION

All technical and scientific terms and expressions used herein have the same definitions as those commonly understood by a person skilled in the art to which the present technology pertains. The definition of some terms and expressions used herein is nevertheless provided below. The section headings used herein are for organizational purposes only and are not to be construed as limiting the subject matter disclosed.

### Definitions

The terminology used herein is for the purpose of describing particular implementations only and is not intended to be limiting. It should be noted that, the singular forms “a”, “an”, and “the” include plural forms as well, unless the content clearly dictates otherwise. It should also be noted that the term “or” is generally employed in its sense including “and/or” unless the context clearly dictates otherwise. Furthermore, to the extent that the terms “including”, “includes”, “having”, “has”, “with”, or variants thereof are used in either the detailed description and/or the claims, such terms are intended to be inclusive in a manner similar to the term “comprising”.

The term “about” or “approximately” means within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, preferably up to 10%, more preferably up to 5%, and more preferably still up to 1% of a given value. Where particular values are described in the application and claims, unless otherwise stated the term “about” meaning within an acceptable error range for the particular value should be assumed.

The expression “additive manufacturing” is used to refer to the construction of a three-dimensional object in which the material is deposited layer by layer. 3D-printing is an example of an additive manufacturing technique.

The term “3D-printing” refers to a technique to create three-dimensional structures for various purposes. In 3D-printing, 3D structures are produced by applying layers of material that are positioned under computer control. The material is repeatedly extruded in formable, viscous state through a nozzle (i.e. printing head or extruder head) and hardens after deposition.

The expression “construction material” (or “building material”) refers to a material suitable for use in construction.

The term “fibers” refers to artificial fibers or natural fibers.

The expressions “artificial fibers”, or “synthetic fibers”, refer to man-made fibers.

The expression “natural fibers” refers to vegetal, animal or mineral fibers.

The expression “hydraulic binder” refers to ingredients that harden after the addition of water. Hydraulic binders can include but are not limited to lime, pozzolan, mortar, and cement.

The expression “construction article” refers to any physical part of a building, such as but not limited to a wall, a floor, a roof, a bridge, a beam, a foundation, a column, a flying buttress, a balustrade, an arch, or any other architectural element. A construction article can also refer to street furniture such as but not limited to a bench, a table, a sculpture, a fountain, a lounge chair, a flower planter, or a bin. Notably, said construction articles can be concrete blocks, bricks, slabs, modular precast systems, insulation modules, packaging (e.g., biodegradable box) or any everyday object (e.g., funeral urn).

The expression “architectural elements” refers to fundamental components that make up the design and construction of a building, serving both functional and aesthetic purposes.

The expression “homogeneous mixture” can be defined as a “uniform mixture” in contrast to a “non-uniform mixture”. These expressions are derived from the idea that a homogeneous mixture has a uniform appearance, or only one phase, because the constituents are substantially evenly distributed.

The term “contour” refers to an outline of a construction material, especially one representing or bounding a shape or form of a construction article, which can be deposited by additive manufacturing, for instance by using a 3D-printer. In the context of the present description, one or several contours can be deposited using an extruder nozzle of a 3D-printer on a same plane.

The term “buttress” or “counterfort” refers to a supportive element that can sustain or reinforce the stability of a construction article, particularly in a concrete block. Said supportive element can also be referred to as an infill in 3D-printing.

The expression “extruder nozzle” of a 3D-printer as used herein can also be referred to as a printing head, an extruder head or a printing nozzle, and in the context of the present description, these expressions can be used interchangeably.

### Cellulosic Fiber-Based Compositions

The present application relates to construction materials compositions for additive manufacturing.

Such compositions are expected to provide enhanced extrudability and self-supporting properties to enable a non-interrupted extrusion process, therefore reducing risks of collapsing and limiting material sagging. The composition of the construction material is expected to greatly influence the behavior of the resulting construction article obtained via additive manufacturing. The present application aims to provide new compositions for additive manufacturing comprising cellulosic fibers.

The present application relates to a composition comprising water, at least one hydraulic binder, and cellulosic fibers, the composition being a construction material for additive manufacturing. The proportion of the cellulosic fibers in the composition can vary. In some implementations, the composition can include at least 5 vol % of cellulosic fibers, from about 10 vol % to about 45 vol % of cellulosic fibers, from about 25 vol % to about 45 vol % of cellulosic fibers, or from about 35 vol % to about 45 vol % of cellulosic fibers.

Integrating a larger quantity of cellulosic fibers into a mixture intended for 3D-printing makes it possible to limit sagging of the material during manufacturing, increase its structural resistance once curing is complete, and improve its environmental footprint by fixing more carbon in the form of plant fiber in the architectural element.

In some implementations, the cellulosic fiber-based compositions as described herein can be referred to as concrete compositions. In some implementations, the cellulosic fiber-based compositions as described herein can be suitable to form concrete construction articles using, for instance, the methods of producing construction articles as described herein.

In some implementations, the cellulosic fibers can have a length ranging from about 0.25 mm to about 20 mm. In other implementations, the cellulosic fibers can have a length ranging from about 0.25 mm to about 12 mm. In other implementations, the cellulosic fibers can have a length from about 1 mm to about 12 mm. In other implementations, the cellulosic fibers can have a length of less than 12 mm. For example, the cellulosic fibers can have a length of about 11 mm, 10 mm, 9 mm, 8 mm, 7 mm, 6 mm, 5 mm, 4 mm, 3 mm, 2 mm, 1 mm, 0.5 mm or 0.25 mm.

In some implementations, the cellulosic fibers can include crushed dry cellulosic fibers. Crushed dry cellulosic fibers can be obtained for instance by grounding dry cellulosic fibers in an electric grinder with rotating blades (speed 28,000 RPM) for 3 minutes, thereby pulverizing the dry cellulosic fibers and forming crushed dry cellulosic fibers having a powdery and/or flaky texture. In some implementations, the crushed dry cellulosic fibers can have a length ranging from about 0.25 mm to about 5 mm. In other implementations, the crushed dry cellulosic fibers can be subsequently moistened to obtain moistened cellulosic fibers. In some implementations, the moistened cellulosic fibers can have a moisture content ranging from about 40% to about 80% humidity. In such implementations, the moistened cellulosic fibers can take the form of a soft granule texture. In some implementations, the moistened cellulosic fibers can have a moisture content ranging from about 60% to about 80%. In some implementations, the moistened cellulosic fibers can have a moisture content of about 65% to about 70%.

In some implementations, the composition can include from about 20 vol % to about 50 vol % of water. In some implementations, the composition can include from about 25 vol % to about 45 vol % of water. In some implementations, the composition can include from about 25 vol % to about 35 vol % of water. In some implementations, the composition can include about 25 vol %, about 30 vol %, about 35 vol %, about 40 vol %, about 45 vol %, or about 50 vol % of water. In some implementations, the amount of water present can be determined according to a desired resulting viscosity of the composition, with a higher water content generally resulting in a lower viscosity.

In some implementations, the composition can include from about 20 vol % to about 60 vol % of the at least one hydraulic binder. In some implementations, the composition can include from about 25 vol % to about 50 vol % of the at least one hydraulic binder. In some implementations, the composition can include about 25 vol %, about 30 vol %, about 35 vol %, about 40 vol %, about 45 vol % or about 50 vol % of the at least one hydraulic binder.

In some implementations, the composition can include from about 10 vol % to about 45 vol % of cellulosic fibers. In some implementations, the composition can include from about 15 vol % to about 45 vol % of cellulosic fibers. In some implementations, the composition can include from about 25 vol % to about 45 vol % of cellulosic fibers. In some implementations, the composition can include about 25 vol %, about 30 vol %, about 35 vol %, about 40 vol % or about 45 vol % of cellulosic fibers. In some implementations, the cellulosic fiber content can be selected to enable enhanced extrudability through a printing nozzle of a 3D-printer and improved self-supporting properties, which in turn can contribute to manufacture a construction article with improved constructability properties, characterized for instance by an improved layer adhesion, reduced sag during and after 3D-printing, a capacity to make sharp turns without fraying or ripping the material, among others. Without being bound by theory, it is expected that a content of cellulosic fibers higher than 65 vol % and, in some embodiments, higher than 55 vol % would impact extrudability (e.g., blockage, air bubbles, crack at extrusion, low layer adhesion during printing and delamination after printing), while a content of cellulosic fibers lower than 10 vol % would impact self-supporting properties (e.g., sagging and dimensional accuracy).

In some implementations, the composition can include for instance from about 20 vol % to about 50 vol % of water, from about 15 vol % to about 50 vol % of the at least one hydraulic binder, and from about 10 vol % to about 45 vol % of cellulosic fibers.

In some implementations, the cellulosic fibers can be selected from the group consisting of synthetic cellulosic fibers, semi-synthetic cellulosic fibers, natural cellulosic fibers and mixtures thereof. In some implementations, the synthetic cellulosic fibers and the semi-synthetic cellulosic fibers can include for instance cellulose nanofibers (CNF), cellulose microfibers (CMF), regenerated cellulose fibers (e.g., rayon and lyocell), bacterial cellulose fibers, and mixtures thereof. In some implementations, the natural cellulosic fibers can be selected from the group consisting of plant-based fibers, agricultural residue fibers, wood-based fibers and mixtures thereof. The agricultural residue fibers can include for instance sugarcane fibers, bagasse fibers and mixtures thereof. The wood-based fibers can include for instance wood chips, bamboo and mixtures thereof. The plant-based fibers can include for instance hemp fibers, flax fibers, jute fibers and mixtures thereof. In some implementations, plant-based fibers can be hemp fibers. In some implementations, the natural cellulosic fibers can be selected from the group consisting of hemp fibers, bamboo fibers, jute fibers, papyrus fibers, flax fibers, sugarcane fibers, bagasse fibers, wood chips and mixtures thereof. For example, the natural cellulosic fibers can be hemp fibers. Maximizing the natural cellulosic fibers quantity in the composition can have positive environmental impact due to higher carbon uptake.

In some implementations, the at least one hydraulic binder can be selected from lime, pozzolan and mixtures thereof. In some implementations, the composition can include from about 5 vol % to about 40 vol % of lime. In some implementations, the composition can include from about 5 vol % to about 35 vol % of lime. In some implementations, the composition can include from about 8 vol % to about 35 vol % of lime. In some implementations, the composition can include about 5 vol %, about 10 vol %, about 15 vol %, about 20 vol %, about 25 vol %, about 30 vol % or about 35 vol % of lime.

In some implementations, the composition can include from about 1 vol % to about 40 vol % of pozzolan. In some implementations, the composition can include from about 2 vol % to about 35 vol % of pozzolan. In some implementations, the composition can include about 1 vol %, about 5 vol %, about 10 vol %, about 15 vol %, about 20 vol %, about 25 vol %, about 30 vol % or about 35 vol % of pozzolan.

In some implementations, the pozzolan may be a silico-aluminous material capable of reacting with calcium hydroxide in the presence of water to form hydraulic compounds. In some implementations, the pozzolan may include pozzolanic materials that can take various forms and be mixed in different proportions, the pozzolanic materials including for instance metakaolin, fly ash, slag, and crushed brick.

In some implementations, the at least one hydraulic binder may include cement. For instance, the composition can include from about 1 vol % to about 25 vol %, about 9 vol % to about 15%, or about 10 vol % to about 15 vol % of cement. In some implementations, the cement can include Portland cement. Without being bound by theory, it is expected that cement can increase mechanical properties of the resulting construction article, such as increased impact resistance, structural capacity, and mechanical strength, among others, without compromising the environmental characteristics of the composition.

In some implementations, the composition can include from about 25 vol % to about 35 vol % of water, from about 8 vol % to about 35 vol % of lime, from about 2 vol % to about 35 vol % of pozzolan, and from about 25 vol % to about 45 vol % of natural cellulosic fibers.

In some implementations, the composition can include about 27 vol % of water, about 18 vol % of lime, about 18 vol % of pozzolan, and about 37 vol % of natural cellulosic fibers.

In some implementations, the composition can include about 30 vol % of water, about 10 vol % of lime, about 20 vol % of pozzolan, and about 40 vol % of natural cellulosic fibers.

In some implementations, the composition can include about 27 vol % of water, about 18 vol % of lime, about 18 vol % of pozzolan, and about 37 vol % of hemp fibers.

In some implementations, the composition can include from about 35 vol % to about 50 vol %, or from about 35 vol % to about 75 vol % of the at least one hydraulic binder, and from about 10 vol % to about 45 vol % of cellulosic fibers. The amount of water present in the composition can depend on the desired viscosity.

In some implementations, the composition can include from about 15 vol % to about 50 vol % of lime and pozzolan, or from about 15 vol % to about 75 vol % of lime and pozzolan, and from about 10 vol % to about 65 vol % of cellulosic fibers. The amount of water present in the composition can depend on the desired viscosity.

In some implementations, the cellulosic fiber-based compositions as described herein can provide at least some of the following benefits:
uninterrupted printing (including no pump blockages);
mixture stability (including no mixture separation);
self-supporting properties;
limited sagging during printing; and/or
good constructability properties of the resulting construction article.

In some implementations, limited sagging during printing can be defined as less than 5° with a vertical axis. In other implementations, limited sagging during printing can be defined as less than 2°.

### Process for Producing Cellulosic Fiber-Based Compositions

The present application also relates to processes for producing cellulosic fiber-based compositions as described herein. Such processes can include one or more of the following steps:
mixing water and at least one hydraulic binder to obtain a hydraulic binder mixture;
adding cellulosic fibers to the hydraulic binder mixture to obtain a cellulosic fibers and hydraulic binder premix; and
mixing the cellulosic fibers and hydraulic binder premix to obtain the cellulosic fiber-based composition.

In some implementations, mixing the water and the at least one hydraulic binder can be performed under conditions suitable for achieving a hydraulic binder mixture that is substantially homogenous. In some implementations, mixing the cellulosic fibers and hydraulic binder premix to obtain the cellulosic fiber-based composition can be performed under conditions suitable for achieving a cellulosic fiber-based composition that is substantially homogenous.

In some implementations, mixing the water and the at least one hydraulic binder to obtain the hydraulic binder mixture can include adding the at least one hydraulic binder to the water or vice versa prior to the mixing. In other implementations, mixing the water and the at least one hydraulic binder to obtain the hydraulic binder mixture can include adding the at least one hydraulic binder to the water or vice versa during the mixing.

In some implementations, when the at least one hydraulic binder comprises two or more hydraulic binders, the hydraulic binders can be added successively to the water during the mixing, or the hydraulic binders can be premixed and then added to the water during the mixing. In other implementations, the hydraulic binders can be premixed, added to a mixer, and the water can be subsequently added to the mixer.

In some implementations, when a cellulosic fiber-based composition that is substantially homogenous is desired to be obtained, a substantially homogeneous distribution of the cellulosic fibers can be assessed by an operator. For example, substantially homogeneous distribution of the cellulosic fibers can be assessed visually by an operator.

In some implementations, the mixing can be performed using a high-speed mixer. In some implementations, the high-speed mixer may be used to mix the water and the at least one hydraulic binder to obtain the hydraulic binder mixture. In some implementations, the high-speed mixer may be used to mix the cellulosic fibers and the hydraulic binder premix to obtain the cellulosic fiber-based composition. In some implementations, the mixing can be performed using a mortar mixer instead of the high-speed mixer.

In some implementations, the mixing can be performed at a mixing speed between about 700 rpm and about 900 rpm. In some implementations, the mixing can be performed for instance at a mixing speed of about 775 rpm to about 825 rpm.

In some implementations, the process can further include adding cement as an additional hydraulic binder. Cement may be added to a hydraulic binder mixture containing at least one of pozzolan and lime. In some implementations, cement may be used to increase the structural capacity of a printed construction article.

In some implementations, the process can further include adjusting a viscosity of the cellulosic fiber-based composition. In such implementations, adjusting a viscosity of the cellulosic fiber-based composition can include adding additional water and/or an additional mixture of water and the at least one hydraulic binder to the cellulosic fibers and hydraulic binder premix and/or to the cellulosic fiber-based composition. In such implementations, the process can include further mixing to obtain the cellulosic fiber-based composition that is substantially homogenous.

In some implementations, the viscosity of the cellulosic fiber-based composition can be between about 50,000 CPS and about 200,000 CPS. In some implementations, the viscosity of the cellulosic fiber-based composition can be between about 70,000 CPS and about 150,000 CPS.

### Method for Producing a Construction Article

The present application also relates to methods for producing a construction article by additive manufacturing. In some implementations, the methods can include one or more of the following steps:
conveying the cellulosic fiber-based composition as described herein from a mixing unit to a 3D-printer using a pumping system;
injecting the cellulosic fiber-based composition in the 3D-printer, wherein the injection can take place within a printing head (inlet port);
extruding the cellulosic fiber-based composition through a printing head (outlet nozzle) on a surface according to a predetermined shape programmed using a computer operatively connected the 3D-printer;
adding additional layers of the cellulosic fiber-based composition layer-by-layer according to the predetermined shape to produce an extruded construction article in 3 dimensions; and
curing the extruded construction article to produce the construction article.

In some implementations, the additional layers of the cellulosic fiber-based composition can be added horizontally layer-by-layer to produce the extruded construction article.

In some implementations, the pumping system can be a constant flow pumping system. In some implementations, the pumping system can include a progressive cavity pump.

In some implementations, the printing head can include a cylindric nozzle of circular section, with no or very little shrinkage compared to the pipe diameter.

In some implementations, a layer height can range from 4 mm to 10 mm. In other implementations, a layer height can be about 4 mm, 5 mm, 6 mm, 7 mm, 8 mm, 9 mm or 10 mm.

In other implementations, a layer height can be about 5 mm to about 7 mm.

In some implementations, the methods described herein can provide an uninterrupted extrusion process. Indeed, the compositions as described herein can contribute to reducing the need for manual mixing or system unblocking interventions. In particular, the methods described herein can be considered as being optimized to avoid separation of the fibers from the other constituents of the composition during the conveying step.

In some implementations, a number of contours can be for instance between 1 and 3. In some implementations, a number of buttresses can be for instance between 1 and 3.

In some implementations, curing the extruded construction article can be performed at a curing temperature between about 15° C. and about 30° C. In other implementations, curing the extruded construction article can be performed for a curing duration between about 20 days and about 30 days. In some other implementations, curing the extruded construction article can be performed at a humidity level between about 40% and about 60% and, in some embodiments, between about 48% and about 52%.

In some implementations, the construction article produced in accordance with the methods described herein can display properties such as compression strength, flexural strength, surface roughness, low density, good weight to strength ratio and integration of assembly geometries.

A 3D-printed construction article can also present the following advantages:
no need for casing allowing complex shapes to be produced at low cost;
facilitated handling due to manufacture of nestable/stackable modules; and
quality control of the modules that are manufacture in advance in a controlled environment.

In the context of the present description, the recitation of an implementation for a variable includes that implementation as any single implementation or in combination with any other implementations or portions thereof. Furthermore, the recitation of an implementation includes that implementation as any single implementation or in combination with any other implementations or portions thereof.

### EXAMPLES

The following non-limiting examples are illustrative implementations and should not be construed as further limiting the scope of the present invention.

Unless otherwise indicated, all numbers expressing quantities of ingredients, conditions, concentrations, properties, stabilities, and so forth used in the specification and claims are to be understood as being modified in all instances by the term “about.” At the very least, each numerical parameter should at least be construed in light of the number of reported significant digits and by applying ordinary rounding techniques. Accordingly, unless indicated to the contrary, the numerical parameters set forth in the present specification and attached claims are approximations that may vary depending upon the properties sought to be obtained. Notwithstanding that the numerical ranges and parameters setting forth the broad scope of the implementations are approximations, the numerical values set forth in the specific examples are reported as precisely as possible. Any numerical value, however, inherently contains certain errors resulting from variations in experiments, testing measurements, statistical analyses and such.

### Example 1: Preparation Processes

The cellulosic fiber-based compositions as described herein can be obtained by the following preparation processes.

### Process 1:

adding water to a mixer;
adding lime (or pozzolan) to the water in the mixer (high speed mortar mixer) while stirring to obtain a mixture of lime (or pozzolan) and water;
adding pozzolan (or lime) to the mixture of lime (or pozzolan) and water while stirring to obtain a substantially homogeneous hydraulic binder mixture;
adding hemp fibers to the substantially homogeneous hydraulic binder mixture while stirring to obtain a hemp fibers and hydraulic binder premix; and
continuing to mix the hemp fibers and hydraulic binder premix to obtain a substantially homogeneous cellulosic fiber-based composition.

### Process 2:

adding water to a mixer;
adding a mixture of pre-mixed lime and pozzolan to the water in the mixer while stirring to obtain a substantially homogeneous hydraulic binder mixture;
adding hemp fibers to the substantially homogeneous hydraulic binder mixture while stirring to obtain a hemp fibers and hydraulic binder premix; and
continuing to mix the hemp fibers and hydraulic binder premix to obtain a substantially homogeneous cellulosic fiber-based composition.

### Process 3:

adding a mixture of pre-mixed lime and pozzolan to a mixer;
adding water to the mixer;
mixing the pre-mixed lime and pozzolan and the water to obtain a substantially homogeneous hydraulic binder mixture;
adding hemp fibers to the substantially homogeneous hydraulic binder mixture while stirring to obtain a hemp fibers and hydraulic binder premix; and
continuing to mix the hemp fibers and hydraulic binder premix to obtain a substantially homogeneous cellulosic fiber-based composition.

For Process 1, Process 2 or Process 3, homogeneity of hemp fiber distribution was visually assessed. For Process 1, Process 2 or Process 3, mixing was performed at speed of about 800 rpm.

If the substantially homogeneous cellulosic fiber-based composition was set to rest for a prolonged period, water or a lime/pozzolan mix was added to the mixture to adjust viscosity before 3D printing. Viscosity was adjusted visually, by taking a handful of the composition in hand and having it slide out of hand smoothly without tearing.

### Example 2: Construction Material Compositions

All compositions described herein can be obtained from Process 1, Process 2 or Process 3 without altering the properties of the resulting compositions.

TABLE 1
Compositions

| | | | | | Portland |
|---|---|---|---|---|---|
| | Water | Lime | Pozzolan | Hemp fibers | cement |
| | (% vol) | (% vol) | (% vol) | (% vol) | (% vol) |
| Composition 1 | 29.6 | 30.2 | 2.3 | 37.9 | — |
| Composition 2 | 30.5 | 31.1 | 2.4 | 36.0 | — |
| Composition 3 | 25.0 | 16.7 | 33.3 | 25.0 | — |
| Composition 4 | 30.0 | 10.0 | 20.0 | 40.0 | — |
| Composition 5 | 30.4 | 8.7 | 17.4 | 43.5 | — |
| Composition 6 | 34.0 | 13.0 | 13.0 | 40.0 | — |
| Composition 7 | 27.0 | 18.0 | 18.0 | 37.0 | — |
| Composition 8 | 28.5 | 14.3 | 14.3 | 43.0 | — |
| Composition 9 | 27.3 | 11.8 | 15.5 | 36.4 | 9.1 |

The hemp fibers used in Composition 1 were crushed dry hemp fibers, and the resulting texture of the crushed dry hemp fibers was powdery and/or flaky.

The hemp fibers used in Composition 2 were crushed to the same size as the crushed hemp fibers of Composition 1. The hemp fibers used in Composition 2 were additionally moistened (68% of humidity), and the resulting texture of the crushed moistened hemp fibers was a brown soft granule. A composition comprising crushed fibers may facilitate its passage through a pumping system during printing, and may produce a more visually homogeneous, less textured mixture. The use of crushed fibers may be associated with lower tensile strength.

The hemp fibers used in Compositions 3-8 were substantially less than 12 mm long (density included between 130 and 150 kg/m³).

The fiber length distribution was investigated for the hemp fibers used in Compositions 3-8 and is as summarized in Table 2. The fiber length distribution of the hemp fibers used in Compositions 3-8 was estimated by image analysis and is summarized in Table 2, where fibers were measured and classified into predefined length ranges, and the reported percentages represent the proportion of fibers within each range relative to the total number of fibers analyzed.

TABLE 2
Fiber length distribution

| Fiber length | Proportion of fibers (%) |
|---|---|
| (mm) | (based on total fiber count) |
| 0-2 | 58.35 |
| 2-4 | 29.38 |
| 4-6 | 7.92 |
| 6-8 | 2.87 |
| 8-10 | 0.83 |
| 10-12 | 0.47 |
| >12 | 0.18 |
| Total | 100 |

All compositions presented a substantially homogeneous fiber distribution.

### General Remarks Regarding Examples 3 and 4

Concrete blocks were prepared by additive manufacturing (i.e., 3D-printing) using a KUKA KR6 R900 Robot 6 axis and a Mai 2Pump Pictor 3D.

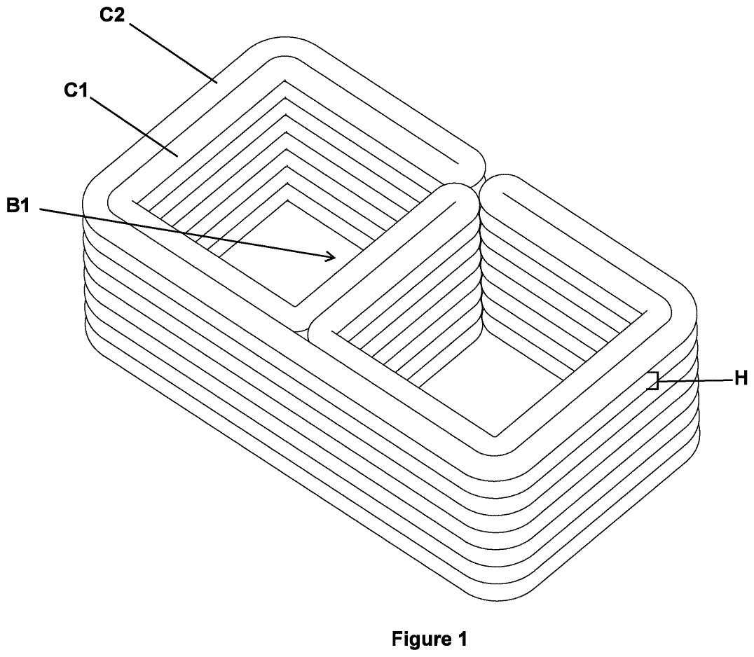

3D-printed blocks: The model block was a rectangular prism comprising two contours and one buttress, as illustrated in FIG. 1, where a first contour C1, a second contour C2, and a buttress 1 are shown. While FIG. 1 depicts an embodiment having two contours and one buttress, other configurations are also possible. As reported in Example 4, the number of contours (from 1 to 3) and buttresses (from 1 to 3) were investigated in order to assess the influence of these parameters on the resulting object. The model block of FIG. 1 is also shown with layers having a height H. The height of each layer can vary from 5 mm to 7 mm. 3D-scans were recorded several times during printing.

A 3D model was cut into layers corresponding to the printing contours. The layers were joined into a continuous contour. A trajectory was determined with this contour to carry out the 3D printing using a robotic arm.

Parameters of the system: Mixer rotation speed was about 800 rpm. A vibrating engine was used to facilitate entry of the composition in the pump. Pumped volume was about 1.2 L/min. Pump rotation speed was about 67 rpm. A range of pressure from 0.992 bar to 1.296 bar was used at the printing nozzle.

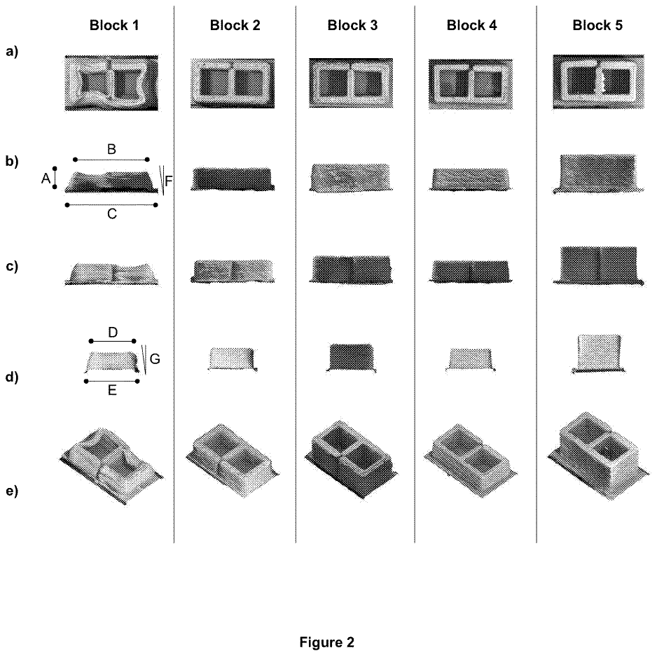

Referring to FIG. 2, dimensions reported were as follows:

$$A = Total height ( mm )$$

$$B = Length at top ( mm )$$

$$C = Length at bottom ( mm )$$

$$D = Width at top ( mm )$$

$$E = Width at bottom ( mm )$$

$$F = Sag angle X ( ° )$$

$$G = Sag angle Y ( ° )$$

### Example 3: Comparative Example

A comparative composition was used in order to assess the effect of the absence of fibers in the mixture. Composition 0: 44.4% vol of lime, 22.2% vol of pozzolan and 33.4% vol of water.

Compositions 0, 1, 2, 3, 4 and 5 were used to prepare concrete blocks having predetermined B and C lengths of 406 mm and predetermined D and E lengths of 203 mm. Dimensions were extracted from scans of the 3D-printed blocks (FIG. 2) and are given in Table 3. Extrusions were performed until total heights A reached arbitrary values, which are not the maximum reachable heights.

TABLE 3
Block dimensions

| | | | | | | | | | Layer |
|---|---|---|---|---|---|---|---|---|---|
| Block | Compo- | A | B | C | D | E | F | G | height |
| No | sition | (mm) | (mm) | (mm) | (mm) | (mm) | (°) | (°) | (mm) |
| 1 | 0 | — | — | — | — | — | — | — | 5.0 |
| 2 | 1 | 111 | 422 | 433 | 236 | 237 | 3.3 | 1.6 | 5.0 |
| 3 | 1 | 133 | 421 | 433 | 230 | 236 | 1.6 | 4.6 | 5.0 |
| 4 | 2 | 104 | 406 | 421 | 219 | 239 | 5.0 | 5.4 | 5.0 |
| 5 | 2 | 185 | 414 | 427 | 235 | 242 | 2.8 | 2.9 | 5.0 |
| 14 | 3 | 185 | 404 | 427 | 218 | 241 | 4.7 | 2.7 | 5.0 |
| 15 | 4 | 185 | 418 | 430 | 230 | 238 | 1.2 | 1.6 | 5.0 |
| 16 | 5 | 205 | 435 | 465 | 242 | 267 | 7.0 | 3.3 | 5.0 |

The fibers' influence on the resulting material sag was assessed by comparing Blocks 2-5 to Block 1. Indeed, Block 1 printed from a composition that did not contain hemp fibers did not present good constructability properties, as shown in FIG. 2.

Crushed moistened fibers used in Composition 2 gave the final construction articles a cracked finish and a dark yellow color (FIG. 2, Blocks No 4 and 5).

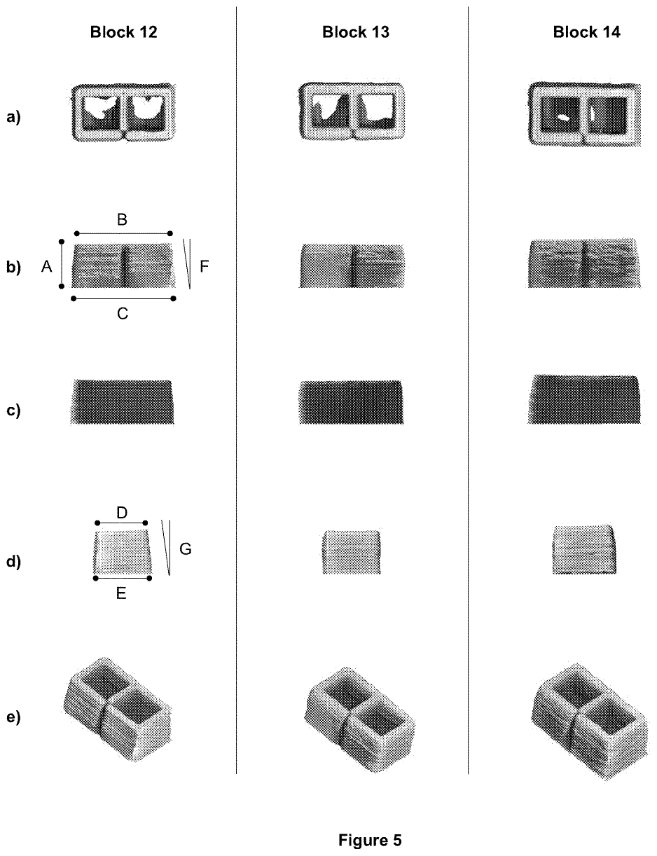

A high percentage of hemp fibers (i.e. >45 vol %) resulted in frequent blockages of the 3D-printing system due to moderate to poor extrudability. Composition 5 had 43.5 vol % fibers, and its corresponding Block No 14 had a maximum sag angle F(°), as shown above in Table 3. Optimum fiber content was reached at around 35-40%, with minimum sag angles obtained with Composition 4 (Table 3) at 40 vol % of fibers (FIG. 5).

Compositions 1, 2, 3 and 4 enabled uninterrupted printing (good extrudability) and presented good material stability (fibers are not separating from the mixture). Compositions 1, 2, 3 and 4 thus presented a good ratio extrudability/constructability.

Composition 6 was also tested for the printing of a Block. Scans were not recorded due to frequent blockages that interrupted printing. The frequent blockages may have been due to hemp fibers absorbing water, thereby increasing the viscosity of the composition. Additionally, an amount of water added to compensate for this absorption may have been insufficient to maintain printability.

### Example 4: Optimization

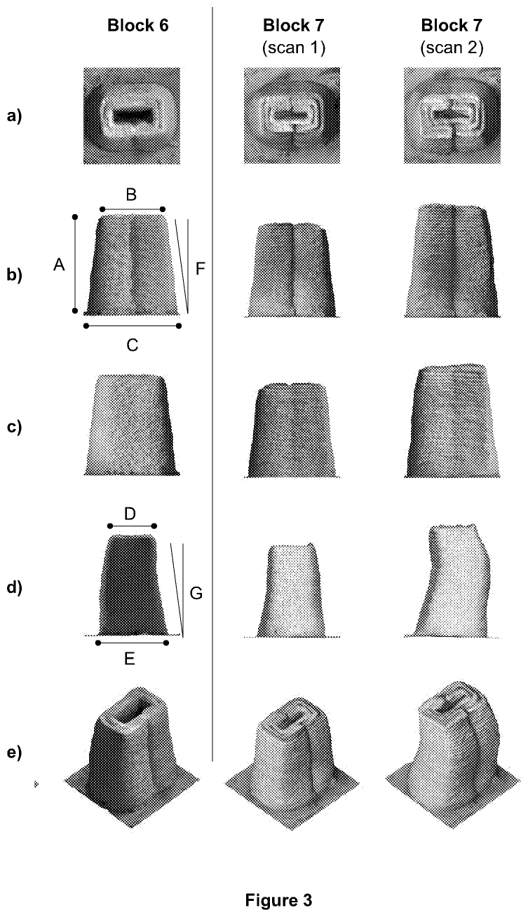

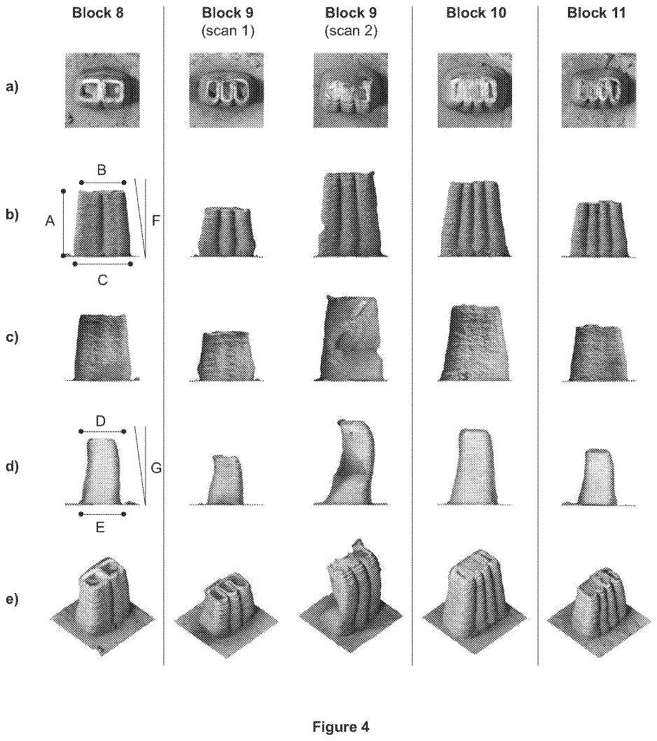

Composition 7 was used to prepare concrete blocks, optimization of the structure involved adding contours and/or buttresses to the 3D-printed blocks. For 3D-printed blocks with two contours, the predetermined dimensions for each of lengths B and C were 194 mm and the predetermined dimensions for each of lengths D and E were 120 mm, with predetermined dimensions increasing when further contours were added. Dimensions were extracted from scans of the 3D-printed blocks (FIGS. 3 and 4) until maximal heights were reached before collapse and the dimensions are shown in Tables 4 and 5. For Blocks 7 and 9, a first scan was recorded during printing and a second scan was recorded just before collapse.

Optimization of layer's height was also investigated in this experiment, as it was expected to have an influence on the impression stability. Layers of 5 mm and 7 mm were extruded (Tables 4 and 5).

Other parameters were investigated for optimization of the concrete blocks, such as the number of contours (Table 4 and FIG. 3). On one hand, doubling of contours in 3D-printing is known to rigidify the printed object. On the other hand, adding too much material could cause collapse due to mass excess. Blocks 5 and 6 were printed with two contours and Block 8 was printed with three contours.

TABLE 4
Block dimensions printed using Composition
7 - Number of contours

| | | | | | | | | Layer |
|---|---|---|---|---|---|---|---|---|
| | A | B | C | D | E | F | G | height |
| Block No | (mm) | (mm) | (mm) | (mm) | (mm) | (°) | (°) | (mm) |
| 6 | 319 | 202 | 282 | 138 | 211 | 8.3 | 7.5 | 5.0 |
| 7 - Scan 1 | 296 | 208 | 271 | 144 | 211 | 6.5 | 7.3 | 7.0 |
| 7 - Scan 2 | 357 | 210 | 286 | 148 | 230 | 5.5 | 6.8 | 7.0 |

*collapse occurred during the scan

Block 7 showed the best combination of maximum height obtained and sag angles, therefore suggesting that for this particular model three contours and a layer height of 7 mm were the optimized parameters.

Buttresses are typically used in order to reinforce a printed object, while saving material compared to a completely filled object. Adding buttresses is expected to strengthen the structure of the printed object against collapsing. However, it is expected that filling the object with an excess of material would destabilize the structure and would cause the material to sag. The optimal number of buttresses was thus investigated (Table 5 and FIG. 4). Block 9 was printed with 1 buttress, Block 10 was printed with 2 buttresses, and Blocks 11 and 12 were printed with 3 buttresses.

TABLE 5
Concrete block dimensions using Composition
7 - Number of buttresses

| | | | | | | | | Layer |
|---|---|---|---|---|---|---|---|---|
| | A | B | C | D | E | | | height |
| Block No | (mm) | (mm) | (mm) | (mm) | (mm) | F (°) | G (°) | (mm) |
| 8 | 270 | 187 | 230 | 114 | 172 | 5.6 | 5.9 | 5.0 |
| 9 - Scan 1 | 204 | 182 | 218 | 100 | 147 | 6.3 | 4.9 | 7.0 |
| 9 - Scan 2 | 349 | 194 | 260 | 115 | 201 | 3.9 | 8.2 | 7.0 |
| 10 | 311 | 191 | 280 | 120 | 206 | 7.1 | 10.0 | 5.0 |
| 11 | 232 | 182 | 235 | 102 | 161 | 7.1 | 7.7 | 7.0 |

Block 9 showed the best combination of maximum height obtained and sag angles, therefore suggesting that for this particular model, 1 buttress and a layer height of 5 mm were the optimized parameters. It was noted that the optimized layer height of Block 9 differed from that of Block 7. Without being bound by theory, a greater layer thickness may be preferable depending on the viscosity of the mix and the minimum flow rate of the pump. For more fluid mixes, increasing the layer height can allow extrusion of an appropriate material quantity per layer where the pump flow rate cannot be reduced further, thereby improving printing stability.

Composition 7 allowed for uninterrupted printing (good extrudability) and presented a good material stability (fibers were not separating from the mixture).

### Example 5: Printing of Cylinders

Compositions 4 and 8 were used to prepare concrete cylinders for compression testing. The cylinders were about 6 inches in diameter with variable heights. The cylinders had 2 contours.

Block 15 was printed using composition 8 and showed the best combination of maximum height and sag angle but resulted in a clog in the pumping system at the end of the printing process, therefore suggesting that the fiber parameter was too high for best printability (43 vol %).

Blocks 16, 17, and 18 were printed using composition 4 which allowed uninterrupted printing. This suggested an optimal maximum amount of fiber (40 vol %). Block 19 was printed using Composition 9 which includes 9.1 vol % of Portland cement, as shown in Table 1. Although the cement enhanced the structural capabilities, the lower amount of lime and pozzolan resulted in a mix that was less viscous, increasing the sagging of the printed block.

TABLE 6
Cylinder dimensions

| | | | | | | | | | Layer |
|---|---|---|---|---|---|---|---|---|---|
| Block | Compo- | A | B | C | D | E | F | G | height |
| No | sition | (mm) | (mm) | (mm) | (mm) | (mm) | (°) | (°) | (mm) |
| 15 | 8 | 297 | 151 | 192 | 155 | 186 | 2.7 | 3.1 | 7.0 |
| 16 | 4 | 145 | 151 | 186 | 150 | 184 | 7.8 | 8.0 | 7.0 |
| 17 | 4 | 148 | 154 | 195 | 152 | 202 | 10.8 | 7.9 | 7.0 |
| 18 | 4 | 148 | 149 | 193 | 149 | 188 | 8.3 | 8.8 | 7.0 |
| 19 | 9 | 204 | 149 | 204 | 149 | 198 | 8.5 | 9.7 | 9.0 |

### Example 6: Compression Tests—7 and 28 Days

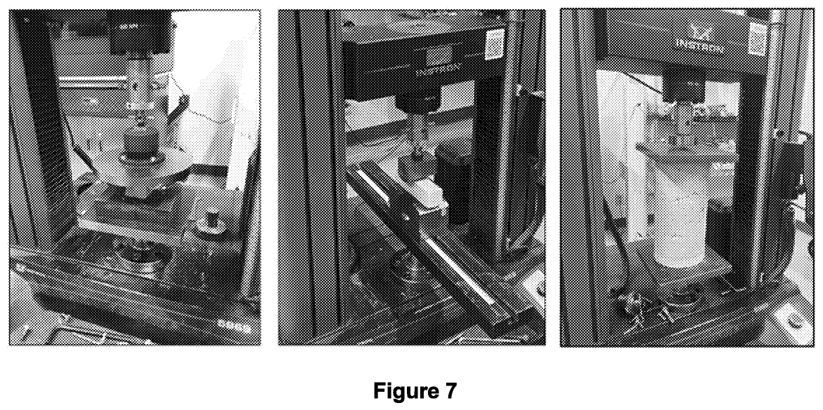

An experimental setup for compression tests on a square specimen is shown in the left panel of FIG. 7. The results for 7-day compression tests are shown below in Table 7.

TABLE 7
Results of 7-day compression tests on 50 mm cubic specimens.

| | Elastic | Compressive | Compressive | | | Compressive | |
|---|---|---|---|---|---|---|---|
| Sample | Compression | Strength | Strength | Compressive | Compressive | Strength | Maximum |
| (50 mm², | Modulus | (kPa) at 1% | (kPa) at 2.5% | Strength (kPa) | Strength (kPa) | (kPa) at 20% | Compressive |
| 7 days) | (kPa) | strain | strain | at 5% strain | at 10% strain | strain | Strength (kPa) |
| M-C2 | 934 | 13.12 | 25.12 | 45 | 82 | 126 | 220 |
| M-C3 | 1147 | 13.41 | 23.63 | 44 | 100 | 142 | 268 |
| M-C4 | 1613 | 19.21 | 41.39 | 94 | 159 | 221 | 391 |
| M-C5 | 913 | 16.49 | 28.48 | 47 | 90 | 139 | 197 |
| Average | 1152 | 16 | 30 | 58 | 108 | 157 | 269 |
| Standard | 325 | 3 | 8 | 24 | 35 | 43 | 86 |
| deviation | | | | | | | |

Results for 28-day compression tests are shown below in Table 8.

TABLE 8
Results of 28-day compression tests on 50 mm cubic specimens.

| | Elastic | | | | | | |
|---|---|---|---|---|---|---|---|
| Sample | Compression | Compressive | Compressive | Compressive | Compressive | Compressive | Maximum |
| (50 mm², | Modulus | Strength (kPa) | Strength (kPa) | Strength (kPa) | Strength (kPa) | Strength (kPa) | Compressive |
| 28 days) | (kPa) | at 1% strain | at 2.5% strain | at 5% strain | at 10% strain | at 20% strain | Strength (kPa) |
| M-C6 | 11288 | 17.24 | 62.88 | 358 | 643 | 941 | 1033 |
| M-C7 | 10431 | 18.8 | 58.55 | 225 | 758 | 1086 | 1087 |
| M-C8 | 13226 | 20.41 | 56.52 | 308 | 826 | 1141 | 1149 |
| M-C9 | 9287 | 17.45 | 75.93 | 486 | 1106 | 1269 | 1317 |
| M-C10 | 18366 | 16.69 | 46.98 | 434 | 953 | 920 | 1034 |
| Average | 12520 | 18 | 60 | 362 | 857 | 1071 | 1124 |
| Standard | 3571 | 1 | 11 | 103 | 179 | 145 | 118 |
| deviation | | | | | | | |

### Example 8: Flexural Tests—7 and 28 Days

An experimental set up for flexural tests is shown in the center panel of FIG. 7. The results of 7-day flexural tests are shown below in Table 9.

TABLE 9
Results of 7-day flexural tests

| | Flexural Strength | Elastic Modulus | Bulk Density |
|---|---|---|---|
| Sample (7 days) | (MPa) | (MPa) | (kg/m³) |
| M-F1 | 0.689 | 20.79 | 778 |
| M-F2 | 0.820 | 19.46 | 765 |
| M-F3 | 0.276 | 3.52 | 879 |
| M-F4 | 0.297 | 3.92 | 872 |
| M-F5 | 0.251 | 2.00 | 933 |
| Average | 0.467 | 9.938 | 845 |
| Standard | 0.267 | 9.339 | 72 |
| deviation | | | |

The results of 28-day flexural tests are shown below in Table 10.

TABLE 10
Results of 28-day flexural tests

| | Flexural Strength | Elastic Modulus | Bulk Density |
|---|---|---|---|
| Sample (28 days) | (MPa) | (MPa) | (kg/m³) |
| M-F6 | 1.048 | 46.16 | 619 |
| M-F7 | 1.408 | 53.30 | 664 |
| M-F8 | 1.078 | 42.00 | 613 |
| M-F9 | 1.244 | 58.50 | 598 |
| M-F10 | 0.887 | 55.24 | 600 |
| Average | 1.133 | 51.04 | 619 |
| Standard | 0.199 | 6.78 | 27 |
| deviation | | | |

### Example 9: Sag Test

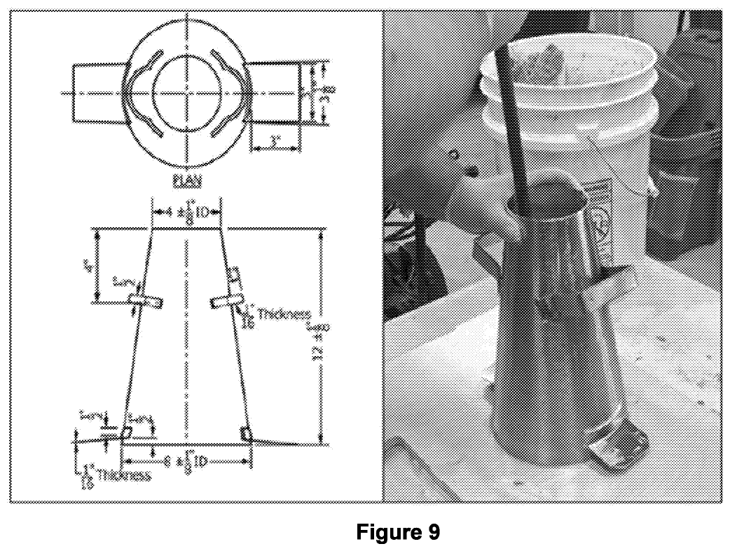

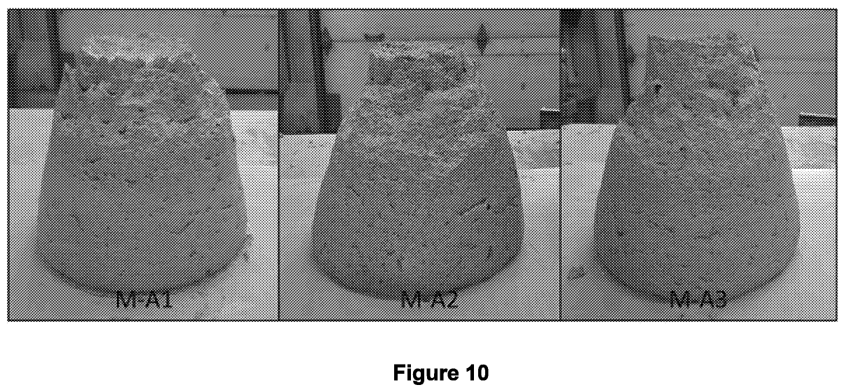

Cone dimensions according to ASTM C143 standards are shown in the left panel of FIG. 9. Filling of the cone for bioconcrete sag tests is shown on the right panel of FIG. 9. Results from the sag test for samples M-A1, M-A2, and M-A3 are shown in FIG. 10, and below in Table 11.

TABLE 11
Results for bioconcrete sag test

| | | Measured | | |
|---|---|---|---|---|
| | Cone Height | Bioconcrete | Slump | |
| Sample | (mm) | Height (mm) | (mm) | Type of Slump |
| M-A1 | 300 | 188 | 112 | True slump |
| M-A2 | 300 | 176 | 124 | True slump |
| M-A3 | 300 | 181 | 119 | True slump |
| Average | 300 | 182 | 118 | |

### Example 11: Viscosity and Shear Tests

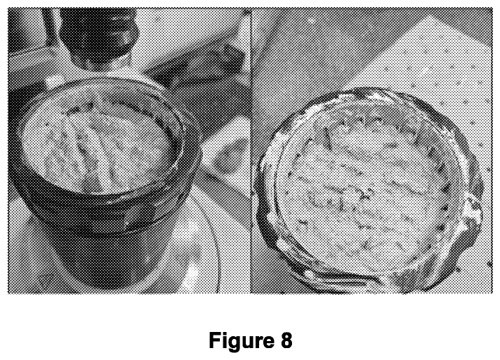

Wet bioconcrete paste used for viscosity tests are shown in the left and right panels of FIG. 8. Viscosity and shear stress test results (rheometer) for Composition 4 are shown below in Table 12. The test reached the torque limit of a BMC system, resulting in saturation of the shear stress measurements. Fitting the data to a Bingham model made it possible to estimate a yield stress of approximately 1350 Pa and a plastic viscosity of approximately 73 Pa-s for Composition 4.

TABLE 12
Viscosity and Shear test results for Composition 4

| | | | | | | Average |
|---|---|---|---|---|---|---|
| Shear | | | Average | Shear | Shear | Shear |
| Rate γ | Viscosity | Viscosity | Viscosity | Stress 1 | Stress 2 | Stress |
| (1/s) | 1 (Pa · s) | 2 (Pa · s) | (Pa · s) | (Pa) | (Pa) | (Pa) |
| 0.5 | 1571.3 | 1785.1 | 1678 | 805.2 | 914.73 | 860 |
| 1 | 1378.1 | 1515.3 | 1447 | 1398.7 | 1538.0 | 1468 |
| 5 | 400.16 | 395.23 | 398 | 2014.7 | 2188.4 | 2102 |
| 10 | 224.91 | 266.56 | 246 | 2262.4 | 2680.7 | 2472 |
| 20 | 137.59 | 135.22 | 136 | 2375.0 | 2703.0 | 2539 |
| 30 | — | — | — | — | — | — |
| 50 | — | — | — | — | — | — |

Viscosity and shear stress test results (rheometer) for Composition 7 are shown below in Table 13. The test reached the torque limit of a BMC system, resulting in saturation of the shear stress measurements. Fitting the data to a Bingham model made it possible to estimate a yield stress of approximately 1000 Pa and a plastic viscosity of approximately 50 Pa-s for Composition 7.

TABLE 13
Viscosity and Shear test results for Composition 7

| | | | | | | Average |
|---|---|---|---|---|---|---|
| Shear | | | Average | Shear | Shear | Shear |
| Rate γ | Viscosity | Viscosity | Viscosity | Stress 1 | Stress 2 | Stress |
| (1/s) | 1 (Pa · s) | 2 (Pa · s) | (Pa · s) | (Pa) | (Pa) | (Pa) |
| 0.5 | 1194.4 | 1225.9 | 1210 | 490.61 | 628.33 | 560 |
| 1 | 1237.7 | 990.72 | 1114 | 1252.6 | 1005.5 | 1129 |
| 5 | 366.38 | 260.79 | 314 | 1839.1 | 1313.0 | 1576 |
| 10 | 205.99 | 141.99 | 174 | 2065.9 | 1499.6 | 1783 |
| 20 | 115.66 | 90.761 | 103 | 2318.8 | 1825.1 | 2072 |
| 30 | 85.583 | 68.061 | 77 | 2642.2 | 2052.6 | 2347 |
| 50 | — | 47.805 | 48 | — | 2402.4 | 2402 |

Numerous modifications could be made to any of the implementations described above without departing from the scope of the present invention. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A cellulosic fiber-based composition, comprising:
water;
at least one hydraulic binder; and
cellulosic fibers present in an amount ranging from about 10 vol % to about 45 vol %;
wherein the cellulosic fiber-based composition is a construction material composition for additive manufacturing.

2. The cellulosic fiber-based composition of claim 1, wherein the cellulosic fibers have a length ranging from about 0.25 mm to about 20 mm.

3. The cellulosic fiber-based composition of claim 1, wherein the cellulosic fibers have a length of less than 12 mm.

4. The cellulosic fiber-based composition of claim 1, wherein the water is present in an amount ranging from about 20 vol % to about 50 vol %; and wherein the at least one hydraulic binder is present in an amount ranging from about 15 vol % to about 50 vol %.

5. The cellulosic fiber-based composition of claim 1, wherein the cellulosic fibers are selected from the group consisting of synthetic cellulosic fibers, semi-synthetic cellulosic fibers, natural cellulosic fibers, and mixtures thereof.

6. The cellulosic fiber-based composition of claim 1, wherein the at least one hydraulic binder is selected from the group consisting of lime, pozzolan, and mixtures thereof.

7. The cellulosic fiber-based composition of claim 6, wherein the cellulosic fibers comprise natural cellulosic fibers; and wherein the cellulosic fiber-based composition comprises:
from about 25 vol % to about 35 vol % of the water;
from about 8 vol % to about 35 vol % of the lime;
from about 2 vol % to about 35 vol % of the pozzolan; and
from about 25 vol % to about 45 vol % of the natural cellulosic fibers.

8. The cellulosic fiber-based composition of claim 1, wherein the cellulosic fibers comprise natural cellulosic fibers and wherein the cellulosic fiber-based composition is selected from the group consisting of plant-based fibers, agricultural residue fibers, wood-based fibers and any mixture thereof.

9. The cellulosic fiber-based composition of claim 1, wherein the cellulosic fibers comprise natural cellulosic fibers and wherein the cellulosic fiber-based composition is selected from the group consisting of hemp fibers, bamboo fibers, jute fibers, papyrus fibers, flax fibers, sugarcane fibers, bagasse fibers, wood chip and any mixture thereof.

10. The cellulosic fiber-based composition of claim 9, wherein the natural cellulosic fibers comprise hemp fibers.

11. The cellulosic fiber-based composition of claim 1, wherein the at least one hydraulic binder comprises from about 1 vol % to about 25 vol % cement.

12. The cellulosic fiber-based composition of claim 1, comprising from about 35 vol % to about 45 vol % of the cellulosic fibers.

13. A process for producing the cellulosic fiber-based composition as defined in claim 1, the process comprising:
mixing the water and the at least one hydraulic binder to obtain a hydraulic binder mixture;
adding the cellulosic fibers to the hydraulic binder mixture to obtain a cellulosic fibers and hydraulic binder premix; and
mixing the cellulosic fibers and hydraulic binder premix to obtain the cellulosic fiber-based composition.

14. The process of claim 13, wherein the mixing is performed using a mortar mixer and/or at between about 700 rpm and about 900 rpm.

15. The process of claim 13, further comprising adding cement to the at least one hydraulic binder prior to the mixing with the water.

16. The process of claim 13, further comprising adjusting a viscosity of the cellulosic fiber-based composition between about 50,000 CPS and about 200,000 CPS by adding an additional amount of water and/or a mixture of the additional amount of water and an additional amount of the at least one hydraulic binder to the cellulosic fibers and hydraulic binder premix and/or the cellulosic fiber-based composition.

17. A method of producing a construction article by additive manufacturing, the method comprising:
conveying the cellulosic fiber-based composition as defined in claim 1 from a mixing unit to a 3D-printer using a pumping system;
injecting the cellulosic fiber-based composition in the 3D-printer;
extruding a layer of the cellulosic fiber-based composition through a printing head on a surface according to a predetermined shape programmed using a computer operatively connected to the 3D-printer;
adding additional layers of the cellulosic fiber-based composition layer-by-layer according to the predetermined shape to produce an extruded construction article in 3 dimensions; and
curing the extruded construction article to produce the construction article.

18. The method of claim 17, wherein the pumping system comprises a progressive cavity pump and/or the printing head comprises a cylindrical nozzle, and the additional layers of the cellulosic fiber-based composition are added horizontally layer-by layer to produce the extruded construction article.

19. The method of claim 17, wherein a layer height of the layer is ranging from about 4 mm to about 10 mm and/or the extruded construction article comprises between 1 and 3 contours and/or the extruded construction article comprises between 1 and 3 buttresses.

20. The method of claim 17, wherein the curing is performed at a curing temperature ranging from about 15° C. to about 30° C. and/or the curing is performed at a humidity level ranging from about 40% to about 60% and/or the curing is performed for a curing duration ranging from about 20 days to about 30 days.
